(19) United States
(12) Patent Application Publication
(10) Pub. No.: US 2025/0361375 A1
(43) Pub. Date: Nov. 27, 2025

(54) ARTICLE WITH CROSS-LINKED POLYETHYLENE

(71) Applicant: W. L. Gore & Associates, Inc., Newark, DE (US)

(72) Inventors: Michael G. Mikhael, Tucson, AZ (US); Qi Wu, Phoenix, AZ (US); Lijun Zou, Phoenix, AZ (US)

(21) Appl. No.: 19/215,046

(22) Filed: May 21, 2025

Related U.S. Application Data
(60) Provisional application No. 63/650,145, filed on May 21, 2024.

(51) Int. Cl. C08J 9/36; C08J 9/22; C09D 123/06

(52) U.S. Cl. CPC C08J 9/365; C08J 9/22; C09D 123/06; C08J 2323/06

(57) ABSTRACT

An article including expanded polyethylene (ePE) and cross-linked polyethylene (PEX) defining a surface that is conformal and continuous on the ePE, the surface including a thickness from about 10 nm to about 500 nm, the surface being about 5% or more weight percent of the ePE, wherein the ePE and the PEX are substantially free of any other element than hydrogen or carbon.

### CROSS-REFERENCE TO RELATED APPLICATION

This application claims the benefit of Provisional Application No. 63/650,145, filed May 21, 2024, which is incorporated herein by reference in its entirety for all purposes.

### FIELD

The present disclosure relates generally to apparatuses, systems, and methods relating to an expanded polyethylene article with a cross-linked polyethylene outer surface. More specifically, the disclosure relates to apparatuses, systems, and methods that provide articles that retain their microstructure during cross-linking.

### BACKGROUND

Polyethylene (PE) is ubiquitous in many industries and products. PE can be expanded to form an expanded polyethylene (ePE), which is used for many different products and applications. PE and ePE may be cross-linked for various reasons. However, current methods of cross-linking PE and ePE can alter the properties for which PE or ePE may be selected. For example, traditional crosslinking methods used for bulk polyethylene, such as γ irradiation or e-beam, compromise the mechanical properties of ePE. In another example, inert gas plasma can be used to cross-link PE, but inert gasses such as Argon or Helium also destroys ePE tensile strength. According to results in these instances, chain scission is predominant over the crosslinks.

### SUMMARY

Articles and methods for forming articles are provided, where the article is an ePE substrate with a cross-linked PE outer surface. The outer surface is treated and/or formed without breaking down the structure of the ePE substrate and without substantial oxidation of the ePE substrate or the cross-linked PE surface.

According to one example (“Example 1”), an article includes expanded polyethylene (ePE); and cross-linked polyethylene (PEX) defining a surface that is conformal and continuous on the ePE, the surface including a thickness from about 10 nm to about 500 nm, the surface being about 5% or more weight percent of the ePE, wherein the ePE and the PEX are substantially free of any other element than hydrogen or carbon.

According to another example (“Example 2”), further to example 1, wherein the article is capable of resisting dissolution in trichlorobenzene when exposed to the trichlorobenzene for about 24 hours, the trichlorobenzene having a temperature from about 160 degrees Celsius to about 200 degrees Celsius.

According to another example (“Example 3”), further to any one of the preceding examples, wherein the article is capable of resisting deformation and breakage when subjected to a tensile force of about 10N.

According to another example (“Example 4”), further to any one of the preceding examples, wherein the article has a melt temperature greater than about 200 degrees Celsius.

According to another example (“Example 5”), further to any one of the preceding examples, wherein the article has a wear score of about 200 or more.

According to another example (“Example 6”), further to any one of the preceding examples, wherein the article has rupture time of over 100 hours when subjected to a burst force resistance test.

According to another example (“Example 7”), further to any one of the preceding examples, wherein an ethylene plasma enhanced chemical vapor deposition (PECVD) process forms the surface of PEX.

According to another example (“Example 8”), further to any one of the preceding examples, wherein the PEX defining the surface that is conformal and continuous on the ePE is continuous and conformal along a microstructure of the ePE.

According to another example (“Example 9”), further to example 8, wherein the microstructure includes a plurality of nodes and fibrils.

According to another example (“Example 10”), further to example 9, wherein the PEX encapsulates each of the plurality of nodes and fibrils individually.

According to another example (“Example 11”), further to any one of the preceding examples, wherein the surface defined by the PEX defines a porous microstructure.

According to another example (“Example 12”), further to any one of the preceding examples, wherein the ePE defines a porous substrate with pores defined by a matrix of nodes and fibrils, and wherein the nodes and fibrils include the PEX surface.

According to another example (“Example 13”), further to any one of the preceding examples, wherein the ePE defines a porous substrate with pores defined by a matrix of nodes and fibrils, and wherein PEX defines a surface of the nodes and fibrils.

According to another example (“Example 14”), an article includes a porous polymer comprising expanded polyethylene (ePE) having a microstructure comprising nodes and fibrils, the nodes being interconnected by the fibrils; and an outer surface of cross-linked polyethylene (PEX), wherein the PEX covers the node and fibrils, wherein the article is microporous.

According to another example (“Example 15”), further to example 14, wherein the outer surface includes a thickness from about 10 nm to about 500 nm.

According to another example (“Example 16”), further to any one of examples 14 and 15, wherein the article is capable of resisting dissolution in trichlorobenzene when the article is exposed to the trichlorobenzene for about 24 hours, the trichlorobenzene having a temperature from about 160 degrees Celsius to about 200 degrees Celsius.

According to another example (“Example 17”), further to any one of examples 14-16, wherein the article is capable of resisting deformation and breakage when subjected to a tensile force about 10N.

According to another example (“Example 18”), further to any one of examples 14-17, wherein the article is capable of resisting melting at a temperature of 200 degrees Celsius and lower.

According to another example (“Example 19”), further to any one of examples 14-18, wherein the porous polymer and the outer surface are free of Oxygen and Nitrogen.

According to another example (“Example 20”), further to any one of examples 14-19, wherein the outer surface is from about 5% to about 20% weight percent with the porous polymer.

According to another example (“Example 21”), further to any one of examples 14-20, wherein the outer surface is a continuous, conformal surface.

According to another example (“Example 22”), further to any one of examples 14-21, wherein the outer surface of PEX defines a surface that is conformal and continuous along a microstructure of the ePE.

According to another example (“Example 23”), further to example 22, wherein the microstructure includes a plurality of nodes and fibrils.

According to another example (“Example 24”), further to example 23, wherein the PEX encapsulates each of the plurality of nodes and fibrils individually.

According to another example (“Example 25”), further to any one of examples 14-24, wherein the outer surface defined by the PEX defines a porous microstructure of the article.

According to another example (“Example 26”), a method of forming an article, the method includes providing a polymer substrate, the polymer substrate comprising expanded polyethylene (ePE) having a microstructure comprising nodes and fibrils, the nodes being interconnected by the fibrils, wherein the nodes and fibrils define pores therebetween to define a porous microstructure; depositing a polymer surface on the polymer substrate via a plasma enhanced chemical vapor deposition (PECVD) process, wherein the polymer surface includes cross-linked polyethylene (PEX), wherein the polymer surface coats the node and fibrils such that the porous microstructure is substantially maintained during deposition to form an article.

According to another example (“Example 27”), further to example 26, further comprising quenching the article by baking in a vacuum oven from about 30 min to about 3 hours from about 50 degrees Celsius to about 80 degrees Celsius.

According to another example (“Example 28”), further to any one of examples 26 and 27, wherein the PECVD process occurs at a pressure below 300m Torr.

According to another example (“Example 29”), further to any one of examples 26-28, wherein the PECVD process includes implementing a hydrocarbon gas.

According to another example (“Example 30”), further to any one of examples 26-29, wherein the PECVD process includes using a flow rate of up to about 500 sccm.

According to another example (“Example 31”), further to any one of examples 26-30, wherein depositing a polymer surface on the polymer substrate includes plasma-energizing ethylene gas.

According to another example (“Example 32”), further to example 31, wherein plasma energizing ethylene gas includes ionizing the ethylene gas.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further

understanding of the disclosure and are incorporated in and constitute a part of this specification, illustrate embodiments, and together with the description serve to explain the principles of the disclosure.

FIG. 1A is an SEM of a dense (e.g., non-porous) polyethylene substrate without a cross-linked polyethylene surface in accordance with an embodiment;

FIG. 1B is an SEM of a dense (e.g., non-porous) polyethylene substrate with a cross-linked polyethylene surface in accordance with an embodiment;

FIG. 2A is an SEM of a porous polyethylene substrate without a cross-linked polyethylene surface in accordance with an embodiment;

FIG. 2B is an SEM of a porous polyethylene substrate with a cross-linked polyethylene surface in accordance with an embodiment;

FIG. 3A is an SEM of a porous polyethylene substrate with fibrils that are relatively thinner as compared to the substrate in FIGS. 3A and 3B, where the substrate is without a cross-linked polyethylene surface in accordance with an embodiment;

FIG. 3B is an SEM of a porous polyethylene substrate with fibrils that are relatively thinner as compared to the substrate in FIGS. 3A and 3B, where the substrate includes a cross-linked polyethylene surface in accordance with an embodiment;

FIGS. 4A-4C are FTIR spectrometry reading of various sample in accordance with various embodiments; and

FIG. 5 is a chart of data relating to the tensile strength as it relates to the percentage of cross linked content on a treated substrate in accordance with various embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

As used herein, the term “burst strength” refers to the pressure at which a film or sheet of the membrane will burst.

As used herein, “surface” as used in reference to a nonporous substrate relates to the surface of the bulk substrate, and as used in reference to a porous substrate relates to the surface of the microstructure of the substrate. By way of example, wherein the porous substate comprises a matrix of nodes and fibrils, “surface” refers to the surface of the nodes and fibrils.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The articles and methods shown in the figures are provided as examples of the various features of the articles and methods discussed herein and, although the combination of those illustrated features is clearly within the scope of invention, that example and its illustration is not meant to suggest the inventive concepts provided herein are limited from fewer features, additional features, or alternative features to one or more of those features shown in various other figures.

An article 10 is discussed having a cross-linked polyethylene (PEX) outer surface wherein only the surface is cross-linked and the remainder of the substrate is not cross-linked. Various articles may be formed with the PEX outer surface, including but not limited to, medical devices, substrates, textiles and so forth. The outer surface being formed of PEX facilitates having the benefits and properties of PEX as it relates to exposure and durability while the bulk properties and benefits of PE are largely unchanged and with a structure that is unchanged from the pre-PEX condition (e.g., in the case of a porous structure, including the diameters and lengths of the nodes and fibrils, is maintained).

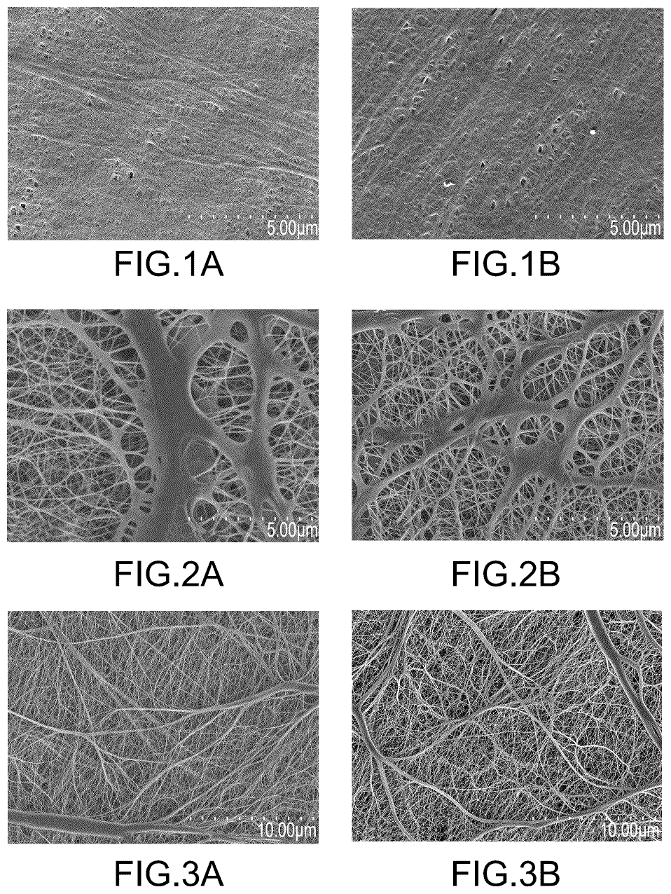

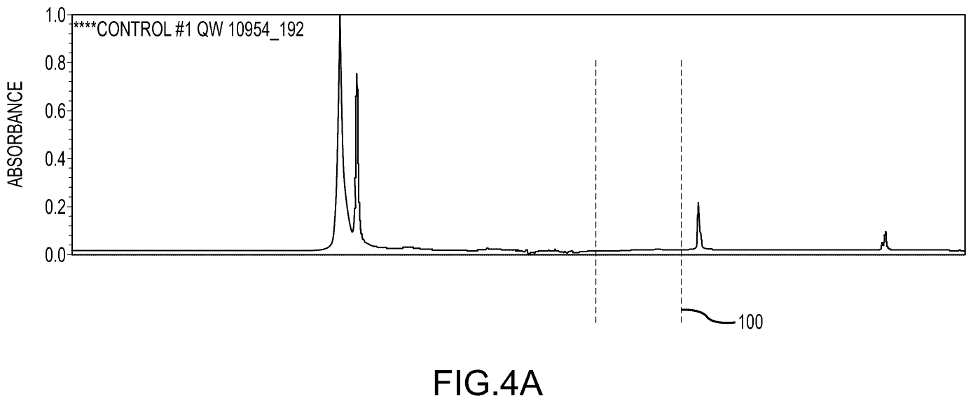

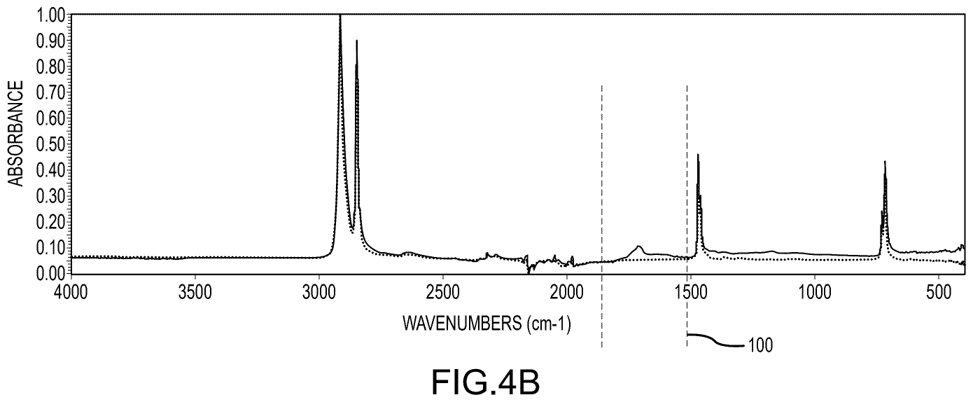

Referring to FIGS. 1A-3B, various structures are shown without an outer surface of PEX and with an outer surface of PEX. The structure (e.g., the microstructure) of the article 10 remains largely unchanged when the outer surface is formed to have a PEX outer surface as described herein. For example, FIG. 1A shows a substantially non-porous polyethylene (PE) substrate that has a dense microstructure without a PEX outer surface. FIG. 1B shows the same non-porous PE substrate that has a dense microstructure with a PEX outer surface. The microstructure is largely unchanged by the process of forming the PEX outer surface (e.g., the surface topology of the substrate is maintained during the plasma enhanced chemical vapor deposition [PECVD] process described herein). FIG. 2A illustrates a porous expanded PE (ePE) substrate with a tight node and fibril microstructure without a PEX outer surface. In some embodiments the ePE substrate has a property of about 6 g/m², about 6.1 g/m², 6.2 g/m², 6.3 g/m², 6.4 g/m², 6.5 g/m², 6.6 g/m², 6.7 g/m², 6.8 g/m², 6.9 g/m², or 7.0 g/m² with a thickness of the ePE substrate being about 50 μM. FIG. 2B shows a porous ePE substrate with a tight node and fibril microstructure, similar to the microstructure in FIG. 2A, with the node and fibril microstructure having a PEX outer surface. The microstructure is largely unchanged by the process of forming the PEX outer surface (e.g., the diameters and lengths of the nodes and fibrils, as well as the bulk dimensions and porosity, are maintained after the PECVD process). FIG. 3A illustrates a porous ePE substrate with a relatively looser node and fibril microstructure (in comparison to the substrate of FIGS. 2A and 2B) without a PEX outer surface. In some embodiments the ePE substrate has a property of about 3 g/m², about 3.1 g/m², 3.2 g/m², 3.3 g/m², 3.4 g/m², 3.5 g/m², 3.6 g/m², 3.7 g/m², 3.8 g/m², 3.9 g/m², or 4.0 g/m² with a thickness of the ePE substrate being about 25 μM. FIG. 3B shows a porous ePE substrate with a relatively looser node and fibril microstructure (in comparison to the substrate of FIGS. 2A and 2B), similar to the microstructure in FIG. 3B, with the nodes and fibrils having a PEX outer surface. In the various examples, the underlying, internal microstructure of the substrate, article, or sample, is largely unchanged by the PEX outer surface (e.g., the diameters and lengths of the nodes and fibrils, as well as the bulk dimensions and porosity, are maintained after the PECVD process). Stated otherwise, the process of forming the PEX outer surface on the nodes and fibrils of the substrate does not alter the microstructure (e.g., the layout of the nodes and fibrils in relation to each other). FIGS. 2A to 3B illustrate that a PEX outer surface may be present on a substrate without substantially changing the underlying topology, microstructure, or morphology of the substrate such that the substrate substantially retains the benefits and properties of the underlying microstructure while adding at least some of the benefits and properties of provided by having a PEX outer surface. For example, the ePE microstructure imparts strength (e.g., tensile strength) to the substrate as evidenced, for example, in ball-burst tests described hereafter, while having the wear abrasion resistance imparted by the PEX outer surface. Stated otherwise, a substrate having a non-crosslinked polyethylene bulk material with a PEX outer surface has greater strength (e.g., as measured by a ball-burst test) than a substrate that has a similar microstructure that is fully crosslinked, and an ePE substrate with a PEX outer surface also has a greater wear abrasion resistance than an ePE structure without a PEX outer surface.

By way of example, various advantageous properties of a PEX outer surface in association with a PE (e.g., ePE) substrate (e.g., PEX surface surrounding non-crosslinked ePE) are discussed herein. For example, a PEX outer surface may provide increased wear or abrasion resistance, which is beneficial in a number of applications, including in implantable medical devices, for example, but not limited to, increasing abrasion resistance and/or durability, including fabrics and textiles which are subjected to repeated abrasion and wear cycles during the lifecycle of a product. In some examples, the article or substrate may include a porous polymer, for example ePE, having a microstructure comprising nodes and fibrils, the nodes being interconnected by the fibrils such that the nodes and fibrils define pores therebetween. The PEX outer surface is defined on the outer surface of each of the nodes and fibrils such that the pores remain open after the PECVD process. Thus, the microstructure of the substrate includes a continuous or unitary PEX outer surface surrounding each of the nodes and fibrils with the interior portion of the nodes and fibrils is non-crosslinked polyethylene. The non-crosslinked polyethylene defining the core of the nodes and fibrils allows the substrate to retain the tensile strength of ePE (e.g., non-crosslinked ePE) while also having the wear resistance of the PEX outer surface. Thus, the PEX outer surface defines a porous microstructure of the article when formed. The article is microporous (e.g., pores defined by the spaces between the microstructure of the nodes and fibrils) after treatment to define the PEX outer surface such that the pores of the ePE are not filled and closed off during formation of the PEX outer surface. Stated otherwise, the microporous structure of ePE is substantially maintained during treatment and formation of the PEX outer surface (e.g., pores may have minimal volume change while maintaining the overall structure forming the pores such that the article includes a similar porosity to that of the untreated ePE).

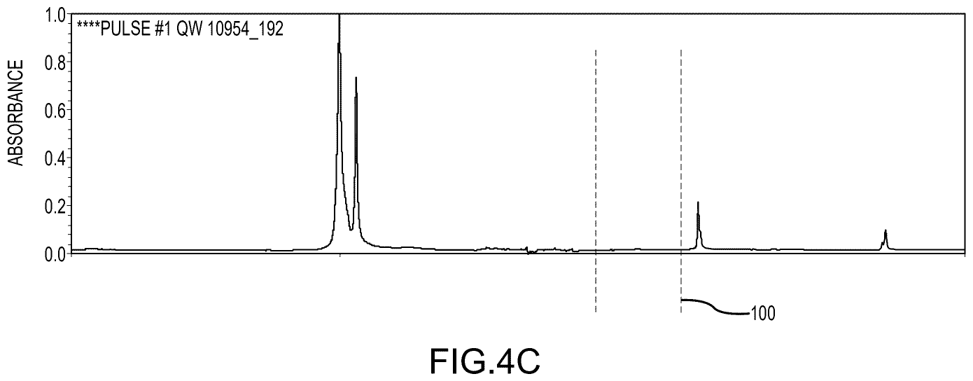

As previously discussed, some methods of cross-linking PE can result in adverse or undesirable effects or results on the properties and/or structure of a substrate. The disclosure herein relates to articles comprising PE (e.g., ePE) having a PEX outer surface. The PEX outer surface may define a surface that is conformal and continuous/unitary on the microstructure of the ePE (e.g., along the outer surface of the nodes and fibrils to fully encapsulate the nodes and fibrils including the outer surfaces of the nodes and fibrils exposed to atmosphere such as nodes and fibrils positioned within pores that are exposed to atmosphere). The thickness of the PEX outer surface may be considered as an average or mean thickness. The PEX outer surface may be from about 5% or more weight percent with the ePE based on process conditions. For example, the PEX outer surface may be from about 5% to about 50% weight percent of the substrate. More specifically, the PEX outer surface may be from about 5% to about 10%, from about 10% to about 20%, from about 20% to about 30%, from about 30% to about 40%, or from about 40% to about 50% weight percent of the substrate. In some embodiments, the ePE and the PEX outer surface are substantially free of any other elements other than hydrogen and carbon. For example, FIG. 4C shows a mass spectrometry reading in which ePE including the PEX outer surface was formed as described herein. The reading shows that there was no observable oxidation as represented in the area bounded by lines 100. FIG. 4A shows the FTIR spectrometry reading of ePE prior to any crosslinking, which also shows no oxidation. For comparison, FIG. 4B is an example of an ePE that was subjected to PECVD using Argon plasma, which resulted in oxidation, as shown by the peak formed between lines 100.

When an ePE substrate includes a PEX outer surface such as those discussed herein, the article or substrate is capable of resisting dissolution in trichlorobenzene when exposed to the trichlorobenzene for about 24 hours, the trichlorobenzene having a temperature from about 160 degrees Celsius to about 200 degrees Celsius. Because the ePE, which would typically dissolve under these conditions, includes the conformal and continuous PEX outer surface (i.e., surrounding the non-crosslinked cores of the node and fibril microstructure of the ePE), which is capable of resisting dissolution under these conditions, the article or substrate remains substantially intact under these exposure conditions.

In some embodiments, the article or substrate as discussed herein is capable of resisting deformation and breakage when subjected to a tensile force from about 5N to about 10N. Because the article or substrate has substantially retained its microstructure or morphology defined by the ePE or otherwise not compromised the mechanical properties of the ePE during cross-linking, the article or substrate is capable of resisting deformation.

In some embodiments, the article or substrate as defined herein has a melt temperature greater than about 200 degrees Celsius. Because the ePE is conformally and continuously coated in PEX, the article or substrate retains its shape, form, microstructure (e.g., node and fibril microstructure), and/or morphology when subjected to temperature at and below about 200 degrees Celsius. This is because PEX has a higher melt temperature than non-crosslinked PE, including ePE. Because the non-crosslinked ePE (e.g., the cores of the nodes and fibrils) is conformally and continuously encapsulated by the PEX outer surface, the article or substrate retains its shape, form, microstructure, and/or morphology when the article or substrate is subjected to temperatures above the melt point of the non-crosslinked ePE but below the melt point of the PEX outer surface. For example, the crosslinked portion of the substrate (i.e., the PEX outer surface) does not melt at 200 degrees Celsius and the non-crosslinked portion of the substrate (i.e., the non-crosslinked ePE interior or core) may melt but is contained by the cross-linked portion.

In some embodiments, the article or substrate as defined herein has an abrasion resistance represented by wear score (per mass normalized) from about 300 to about 400 (calculation of wear score is provided below) when the vapor deposition processes as described herein are implemented for 120 minutes. The outer surface of PEX increases the abrasion resistance of the article or substrate such that the article or substrate has enhanced wear resistance. By way of comparison, an ePE substrate (i.e., non-crosslinked) may have a wear score from about 25 to about 175 in comparison to a wear score of from about 200 to about 400 when provided with a PEX outer surface such as that described above for at least 30 minutes. In other words, the substrate with a PEX outer surface may exhibit an increased wear score of 300% or more, in various examples.

In some embodiments, the article or substrate as defined herein has a burst force resistance or burst strength over a longer period of time for articles prepared according to the disclosure. For example, materials disclosed herein resist bursting from about 200 to about 1,000 hours as compared to ePE samples that are untreated which resist bursting for about 100 hours when subjected to the tests described hereafter. The burst strength of the film or sheet of the membrane depends largely on the tensile strength and extensibility of the material.

In some embodiments, the PEX coats the ePE using a plasma enhanced chemical vapor deposition (PECVD) process implementing ethylene gas that is plasma-energized. The ethylene is ionized and is used to both crosslink the ePE as well as deposit a thin layer on the ePE. Stated otherwise, PECVD may be implemented to both deposit PEX on the ePE material and to crosslink outer surface of the ePE material. The methods described herein allow this to occur at lower temperatures (e.g., below the melt temperature of non-crosslinked ePE), which reduces the likelihood of decomposition of the substrate or article or changes in the microstructure (e.g., node and fibril microstructure and microporosity) which contribute to the material properties (e.g., tensile strength). PECVD also allows for conformal, continuous surface to be defined on the ePE substrate (e.g., via deposition and via cross-linking of the outer surface of the ePE substrate) in three dimensions and in small internal spaces open to exterior surfaces of the ePE material. PECVD is implemented surfactant-free, water-free, and solvent-free, which maintains the structural integrity of the ePE substrate (e.g., the tensile strength) and provides the PEX outer surface such that the microstructure of the ePE substrate is largely unchanged by the PECVD process (e.g., the diameters and lengths of the nodes and fibrils are maintained during the PECVD process). PECVD is effective on the outer surfaces of the ePE substrate while not result in bulk property changes to the ePE substrate. It is understood that an ePE substrate that is crosslinked to the extent of bulk property changes (e.g., fully crosslinked) becomes more brittle and therefore may have lower tensile strength as compared to bulk non-crosslinked ePE or the substrate discussed herein with non-crosslinked ePE having a PEX outer surface.

In some embodiments, the PECVD process implements ethylene. Implementing ethylene in the PECVD process results in the surfaces of the ePE being coated with a PEX outer surface. Implementing ethylene in the PECVD process also overcomes at least some of the limitations of using inert plasma gasses such as Argon or Helium, which can decrease tensile strength exhibited by ePE.

In some embodiments, a vacuum plasma chamber is implemented for providing a PEX outer surface. The vacuum plasma chamber may be supplied with RF power from about 100 W to about 2 kW. In some embodiments, the vacuum plasma chamber is supplied with RF power of about 100 W, of about 250 W, of about 500 W, of about 750 W, of about 1 KW, of about 1.25 kW, of about 1.50 KW, of about 1.75 kW, and of about 2.00 kW. In some embodiments, the PECVD process is implemented from about 50 W to about 100 W for about 10 minutes to about 1 hour, although the process may be implemented over longer periods of time.

In some embodiments, the base pressure implemented in the PECVD process may be from about 10 mtorr to about 300 mtorr. In some embodiments, the base pressure is from about 10 mtorr to about 20 mtorr, from about 20 mtorr to about 50 mtorr, from about 50 mtorr to about 100 mtorr, from about 100 mtorr to about 500 mtorr, from about 500 mtorr to about 1,000 mtorr, or any other ranges therebetween. In some embodiments the base pressure is below about 50 mtorr, below about 100 mtorr, below 150 mtorr, below 200 mtorr, below 300 mtorr, or below 1,000 mtorr.

In some embodiments, a hydrocarbon gas is implemented in the PECVD process. For example, in some embodiments an ethylene gas may be used to form the PEX outer surface on the ePE. In some embodiments an acetylene gas may be used to form the PEX outer surface on the ePE. In some embodiments any all the aliphatic hydrocarbon (CxHy) volatile may be implemented (e.g., methane). The PECVD process may be implemented with a flow rate from about 50 sccm to about 500 sccm. For example, in some embodiments, the flow rate is from about 50 sccm to about 100 sccm, from about 100 sccm to about 250 sccm, from about 250 sccm to about 500 sccm, or any other ranges therebetween. In some embodiments the flow rate is below about 100sccm, is below about 200 sccm, is below about 300 sccm, is below about 400 sccm, or is below about 500 sccm.

In some embodiments, a method of forming an article or substrate includes providing a polymer substrate, the polymer substrate including ePE having a microstructure comprising nodes and fibrils, the nodes being interconnected by the fibrils and defining pores therebetween. The method further includes forming a crosslinked outer surface on the polymer substrate via PECVD process as discussed herein. This results in the polymer surface including PEX, wherein the polymer surface coats only the node and fibrils such that the pores are free of the polymer surface to form an article. In some embodiments, the method includes quenching the article or substrate by baking the article or substrate in a vacuum oven from about 30 min to about 3 hours at a temperature from about 50 degrees Celsius to about 80 degrees Celsius.

The methods and procedures described herein relating to the PECVD crosslinking reactions (e.g., among a deposited ethylene and a substrate such as an ePE membrane) occur on the molecular level of ePE polymeric chains that forms the nodes and fibrils, and not on the structural level of the membrane. Therefore, there is no bonding/bridging among fibrils and nodes. This allows the substrate to maintain its membrane structure (unchanged porosity and permeability) while improving the surface properties (abrasion and oxidation resistance) of at least partially crosslinked node and fibril surfaces.

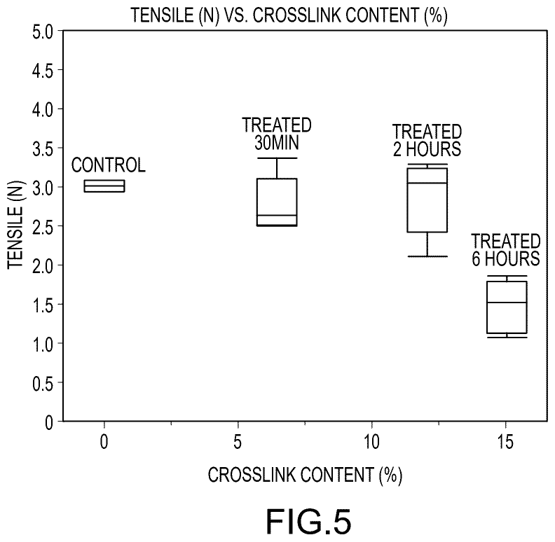

Referring to FIG. 5, a chart is provided illustrating the tensile strength of various samples that have been treated via the methods described herein. The X-axis includes the tensile strength of sample subjected to a tensile strength test, and the Y-axis includes the percentage of the sample that was crosslinked using the methods described herein. The percentage of the sample that was cross-linked was altered by the length of time that the sample was subjected to the processes described herein. An untreated sample included strength of about 3N, wherein the first sample was an untreated ePE sample. It is typically understood that exceeding a threshold of the level of cross-linking on a PE substrate reduces the tensile strength substrate as cross-linked polyethylene is relatively more brittle than the non-crosslinked PE. As shown in FIG. 5, partially cross-linked ePE substantially retains its tensile strength at around 6% cross-link content and 12% cross-linked content and begins to exhibit decreased tensile strength after 15% cross-linked content. By controlling the degree of crosslinking of the ePE substrates discussed herein, the brittleness of crosslinked PE is avoided while being able to benefit from the desirable features of the crosslinked PE. The methods described herein thus allow ePE substrates to be treated in such a way to retain the desirable properties of ePE such as tensile strength while also exhibiting desirable properties of PEX such as increased abrasion resistance and so forth as further detailed herein.

### TEST METHODS

It should be understood that although certain methods and equipment are described below, other methods or equipment determined suitable by one of ordinary skill in the art may be alternatively utilized.

### Test Methods

### Ball Burst Test

The mechanical strength of a cross-linked ePE substrate prepared in accordance with the present disclosure was measured by subjecting a sample to a load pressure.

A sample was fixed taut in a frame with a 45 mm diameter opening. The sample in the frame was placed into a universal testing machine AG-I of Shimadzu Corporation, Japan with an environmentally controlled chamber with the temperature and relative humidity inside of the chamber being 23° C. and 80%, respectively. A steel ball with a diameter of 1 mm, supported on a post, was pressed into the suspended membrane at a constant rate of 100 mm/min. The maximum load generated by the system at the sample's break was recorded and that value is called the ball burst strength. 25% of the ball burst strength is applied on the membrane and the time to break the membrane is recorded as burst time.

### Wear Abrasion Test

The mechanical strength of a cross-linked ePE substrate prepared in accordance with the present disclosure was measured by subjecting a sample to the test described below.

Cut sample from membrane sheet (40 mm×30 mm). Note MD/TD orientation.

Measure mass with balance. Calculate Mass/Area.

Measure thickness of the sample with light pressure contact.

Place a piece of 3M™ PN8992 Green Polyester tape (adhesive side down) onto the test zone of the fixture block.

Load sample onto fixture block. For most testing mount MD direction to be the test direction. Clamp sample down with fixture block retainer, try to maintain the material taught, without wrinkles.

Mount sample in tribometer.

Fill tribometer bath with deionized water until sample is submerged. Set bath temperature to 37 degrees Celsius.

Load 0.00185″ diameter nitinol wire (wound and tempered around a 0.060″ pin) in tribometer holder.

### Test Array.

The tribometer will run a program that will test the sample at multiple locations:

Location 1: 1N downward force, 5 Hz oscillation of 2 mm, test time 10 min

Location 2:1.75N downward force, 5 Hz oscillation of 2 mm, test time 10 min

Location 3:2.5N downward force, 5 Hz oscillation of 2 mm, test time 10 min

Location 4: only for samples that have not seen a breakthrough, repeat the 2.5N forces, 5 Hz oscillation of 2 mm, test time 1 hr.

Once test array is complete, analyze the trace for each location to determine the time of breakthrough in seconds. Breakthrough is noted as a spike in the Fx force or and step change increase in the COF when the wire wears through the material and makes contact with the polyester tape below. If no breakthrough is noted record 600 seconds as the breakthrough time. Remove and dry sample, then confirm the breakthrough using a microscope to visualize whether there was a breakthrough or not.

Calculate the weighted wear score and other normalization factors as follows:

$$Wear Score = ( 1 * time in seconds to breakthrough at 1 N ) + ( 1.75 * time in seconds to breakthrough at 1.75 N ) + ( 2.5 * time in seconds to breakthrough at 2.5 N ( use location 4 time if no breakthrough at location 3 ) )$$

$$Wear Score per Micron = Wear Score / Thickness$$

$$Wear Score per Mass / Area = Wear Score / ( Mass / Area )$$

$$Wear Score / ( ( Mass / 1200 mm \hat{} 2 ) * ( 1 cm \hat{} 3 / \text{.96} g ) * ( 1000 m \hat{} 3 / cm \hat{} 3 ) * ( 1000 um / mm ) )$$

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. An article comprising:
expanded polyethylene (ePE); and
cross-linked polyethylene (PEX) defining a surface that is conformal and continuous on the ePE, the surface including a thickness from about 10 nm to about 500 nm, the surface being about 5% or more weight percent of the ePE,
wherein the ePE and the PEX are substantially free of any other element than hydrogen or carbon.

2. The article of claim 1, wherein the article is capable of resisting dissolution in trichlorobenzene when exposed to the trichlorobenzene for about 24 hours, the trichlorobenzene having a temperature from about 160 degrees Celsius to about 200 degrees Celsius.

3. The article of claim 1, wherein the article is capable of resisting deformation and breakage when subjected to a tensile force of about 10N.

4. The article of claim 1, wherein the article has a melt temperature greater than about 200 degrees Celsius.

5. The article of claim 1, wherein the article has a wear score of about 200 or more.

6. The article of claim 1, wherein the article has rupture time of over 100 hours when subjected to a burst force resistance test.

7. The article of any claim 1, wherein the PEX defining the surface that is conformal and continuous on the ePE is continuous and conformal along a microstructure of the ePE.

8. The article of claim 7, wherein the microstructure includes a plurality of nodes and fibrils.

9. The article of claim 8, wherein the PEX encapsulates each of the plurality of nodes and fibrils individually.

10. The article of claim 1, wherein the surface defined by the PEX defines a porous microstructure.

11. The article of claim 1, wherein the ePE defines a porous substrate with pores defined by a matrix of nodes and fibrils, and wherein PEX defines a surface of the nodes and fibrils.

12. An article comprising:
a porous polymer comprising expanded polyethylene (ePE) having a microstructure comprising nodes and fibrils, the nodes being interconnected by the fibrils; and
an outer surface of cross-linked polyethylene (PEX), wherein the PEX covers the node and fibrils, wherein the article is microporous.

13. The article of claim 12, wherein the outer surface includes a thickness from about 10 nm to about 500 nm.

14. The article of claim 12, wherein the porous polymer and the outer surface are free of Oxygen and Nitrogen.

15. The article of claim 12, wherein the outer surface is from about 5% to about 20% weight percent with the porous polymer.

16. The article of claim 12, wherein the outer surface is a continuous, conformal surface.

17. The article of claim 12, wherein the outer surface of PEX defines a surface that is conformal and continuous along a microstructure of the ePE.

18. The article of claim 17, wherein the microstructure includes a plurality of nodes and fibrils.

19. The article of claim 18, wherein the PEX encapsulates each of the plurality of nodes and fibrils individually.

20. A method of forming an article, the method comprising:
providing a polymer substrate, the polymer substrate comprising expanded polyethylene (ePE) having a microstructure comprising nodes and fibrils, the nodes being interconnected by the fibrils, wherein the nodes and fibrils define pores therebetween to define a porous microstructure;
depositing a polymer surface on the polymer substrate via a plasma enhanced chemical vapor deposition (PECVD) process, wherein the polymer surface includes cross-linked polyethylene (PEX), wherein the polymer surface coats the node and fibrils such that the porous microstructure is substantially maintained during deposition to form an article.

21. The method of claim 20, further comprising quenching the article by baking in a vacuum oven from about 30 min to about 3 hours from about 50 degrees Celsius to about 80 degrees Celsius.

22. The method of claim 20, wherein the PECVD process occurs at a pressure below 300 mTorr.

23. The method of claim 20, wherein the PECVD process includes implementing a hydrocarbon gas.

24. The method of claim 20, wherein the PECVD process includes using a flow rate of up to about 500 sccm.

25. The method of claim 20, wherein depositing a polymer surface on the polymer substrate includes plasma-energizing ethylene gas.

26. The method of claim 25, wherein plasma energizing ethylene gas includes ionizing the ethylene gas.
